(19) United States
(12) Patent Application Publication
(10) Pub. No.: US 2025/0025784 A1
(43) Pub. Date: Jan. 23, 2025

(54) GAME INTERACTION METHODS AND SYSTEMS

(71) Applicant: Tencent Technology (Shenzhen) Company Limited, Shenzhen (CN)

(72) Inventor: Fenlin Cai, Shenzhen (CN)

(21) Appl. No.: 18/910,151

(22) Filed: Oct. 9, 2024

Related U.S. Application Data
(63) Continuation of application No. PCT/CN2023/123237, filed on Oct. 7, 2023.

(30) Foreign Application Priority Data
Nov. 1, 2022 (CN) 202211357594.2

(51) Int. Cl. A63F 13/52

(52) U.S. Cl. CPC A63F 13/52

(57) ABSTRACT

Game interaction techniques are described herein. A method may include: displaying a target page, a plurality of level controls being displayed on the target page; displaying a first virtual scene in response to an operation instruction for a first level control in the plurality of level controls; displaying, in the first virtual scene, a second virtual object corresponding to each battle wave included in a first game region; and displaying a second virtual scene based on a hit point of the second virtual object being not greater than a reference value, the second virtual scene being a virtual scene corresponding to a second game region, and the second game region being a game region adjacent to the first game region and after the first game region. Time for a target object to search for the second virtual object can be reduced, a game tempo is speeded up, and efficiency of game interaction is improved.

### RELATED APPLICATION

This application is a continuation application of PCT Application PCT/CN2023/123237, filed Oct. 7, 2023, which claims priority to Chinese Patent Application No. 202211357594.2, filed on Nov. 1, 2022, each entitled “GAME INTERACTION METHOD AND APPARATUS, DEVICE, AND COMPUTER-READABLE STORAGE MEDIUM”, and each of which is incorporated herein by reference in its entirety.

### FIELD

Aspects described herein relate to the field of computer technologies, and in particular, to a game interaction method and apparatus, a device, and a computer-readable storage medium.

### BACKGROUND

With continuous development of computer technologies, more and more entertainment games operated on terminals emerge, for example, multiplayer online battle arena games developed based on a client or server architecture.

In the related art, a player may control a first virtual object in a game to move in a game map. When the first virtual object encounters a second virtual object, such as a monster, during the movement, the player may control the first virtual object to damage the second virtual object.

### SUMMARY

The aspects described herein provide a game interaction method and apparatus, a device, and a computer-readable storage medium, to improve efficiency of game interaction and reduce a player churn rate. Technical solutions are as follows.

According to an aspect, an aspect described herein provides a game interaction method, performed by a terminal device, and including:
displaying a target page, a plurality of level controls being displayed on the target page, one level control corresponding to one game level, one game level including at least one game region, one game region including at least one battle wave, and the game region being a partial area of a game map;
displaying a first virtual scene corresponding to a first game region in response to an operation instruction for a first level control in the plurality of level controls, a first virtual object being displayed in the first virtual scene, the first game region being a game region that a target object corresponding to the first virtual object has challenged but not passed through in a plurality of candidate game regions, and the candidate game region being a game region included in a game level corresponding to the first level control;
displaying, in the first virtual scene, a second virtual object corresponding to each battle wave included in the first game region; and
displaying a second virtual scene corresponding to a second game region based on a hit point of the second virtual object being not greater than a reference value, the second game region being a game region adjacent to the first game region and after the first game region in the plurality of candidate game regions, and the second virtual scene being configured for the target object to control the first virtual object to perform interaction with a virtual object corresponding to each battle wave included in the second game region.

According to another aspect, an aspect described herein provides a game interaction apparatus, including:
a display module, configured to display a target page, a plurality of level controls being displayed on the target page, one level control corresponding to one game level, one game level including at least one game region, one game region including at least one battle wave, and the game region being a partial region of a game map,
the display module being further configured to display a first virtual scene corresponding to a first game region in response to an operation instruction for a first level control in the plurality of level controls, a first virtual object being displayed in the first virtual scene, the first game region being a game region that a target object corresponding to the first virtual object has challenged but not passed through in a plurality of candidate game regions, and the candidate game region being a game region included in a game level corresponding to the first level control;
the display module being further configured to display, in the first virtual scene, a second virtual object corresponding to each battle wave included in the first game region; and
the display module being further configured to display a second virtual scene corresponding to a second game region based on a hit point of the second virtual object being not greater than a reference value, the second game region being a game region adjacent to the first game region and after the first game region in the plurality of candidate game regions, and the second virtual scene being configured for the target object to control the first virtual object to perform interaction with a virtual object corresponding to each battle wave included in the second game region.

According to another aspect, an aspect described herein provides a computer device, including a processor and a memory, the memory having at least one piece of program code stored therein, the at least one piece of program code being loaded and executed by the processor to cause the computer device to implement any one of the foregoing game interaction methods.

According to another aspect, a nonvolatile computer-readable storage medium is further provided, having at least one piece of program code stored therein, the at least one piece of program code being loaded and executed by a processor to cause a computer to implement any one of the foregoing game interaction methods.

According to another aspect, a computer program or a computer program product is further provided, having at least one computer instruction stored therein, the at least one computer instruction being loaded and executed by a processor to implement any one of the foregoing game interaction methods.

According to the technical solutions provided in the aspects described herein, the game map is divided into a plurality of game regions with areas smaller than that of the game map. When the operation instruction for the first level control in the plurality of level controls displayed on the target page is received, the first virtual object controlled by the target object is displayed in the first game region of the game level corresponding to the first level control. In the first game region, the first virtual object receives at least one battle wave, and enters the second game region of the game level corresponding to the first level control only when the hit point of the second virtual object included in each battle wave is not greater than the reference value. According to the method, the game map is divided into the plurality of game regions, a game is played in only one game region at a time, an area of the game region is smaller than that of the game map, and the target object can control the first virtual object to directly perform interaction with the second virtual object in the game region. Therefore, the target object does not need to frequently control the first virtual object to move in the game map to search for the second virtual object. This can reduce time for the target object to search for the second virtual object, speed up a game tempo, and improve efficiency of game interaction, thereby improving game appeal to the target object and reducing a player churn rate.

### BRIEF DESCRIPTION OF THE DRAWINGS

FIG. 1 is a schematic diagram of an implementation environment of a game interaction method according to an aspect described herein.

FIG. 2 is a flowchart of a game interaction method according to an aspect described herein.

FIG. 3 is a schematic diagram of displaying of a target page according to an aspect described herein.

FIG. 4 is a schematic diagram of displaying of a target content according to an aspect described herein.

FIG. 5 is a schematic diagram of game regions included in any game level and battle waves included in each game region according to an aspect described herein.

FIG. 6 is a schematic diagram of displaying of a first virtual scene according to an aspect described herein.

FIG. 7 is a schematic diagram of a process of displaying prompt information and canceling the displaying of the prompt information in a first virtual scene according to an aspect described herein.

FIG. 8 is a schematic diagram of displaying of another first virtual scene according to an aspect described herein.

FIG. 9 is a schematic diagram of displaying of a servicing page according to an aspect described herein.

FIG. 10 is a schematic diagram of determining duration required for passing through a game level according to an aspect described herein.

FIG. 11 is a flowchart of a game interaction method according to an aspect described herein.

FIG. 12 is a schematic structural diagram of a game interaction apparatus according to an aspect described herein.

FIG. 13 is a schematic structural diagram of a game interaction apparatus according to an aspect described herein.

FIG. 14 is a schematic structural diagram of a terminal device according to an aspect described herein.

FIG. 15 is a schematic structural diagram of a server according to an aspect described herein.

### DETAILED DESCRIPTION

To make objectives, technical solutions, and advantages described herein clearer, implementations described herein are further described below in detail with reference to accompanying drawings.

Abbreviations or key terms involved in the aspects described herein are defined below.

Shooting game: The shooting game is a game in which a virtual item is used for remote attack, including but not limited to a first-person shooting game and a third-person shooting game.

Third-person perspective: The third-person perspective is a perspective in which an in-game camera is located at a specific distance away from a player-controlled virtual object, so that the player-controlled virtual object and all elements in a specific surrounding environment can be seen in a virtual scene.

Open world: The open world means that a battle scene in a game is completely free and open, a player-controlled virtual object may automatically explore in any direction, and a distance between boundaries of various directions is excessively large. In addition, various challengeable virtual objects may exist in a game level, and a player may choose whether to control the player-controlled virtual object to challenge the challengeable virtual object.

Virtual scene: The virtual scene is a scene provided (or displayed) when an application program is run on a terminal device. The virtual scene is a scene created for a virtual object to perform activities. The virtual scene may be a two-dimensional virtual scene, a 2.5-dimensional virtual scene, a three-dimensional virtual scene, or the like. The virtual scene may be a simulated scene of the real world, may be a semi-simulated scene of the real world, or may be a purely fictional scene. For example, the virtual scene involved in the aspects described herein is a three-dimensional virtual scene.

Virtual object: The virtual object is a movable object in a virtual scene. The movable object may be a virtual person, a virtual animal, a cartoon person, or the like. A target object may control the virtual object through a peripheral component or in a manner of tapping and touching a display screen. Each virtual object has a shape and a volume in the virtual scene, and occupies some space in the virtual scene. For example, when the virtual scene is a three-dimensional virtual scene, the virtual object is a three-dimensional model created based on a skeletal animation technology.

In the related art, a player may control a first virtual object in a game to move in a game map. When the first virtual object encounters a second virtual object, such as a monster, during the movement, the player may control the first virtual object to damage the second virtual object. However, the game map involves an excessively large region, and second virtual objects are scattered in various corners in the game map. As a result, the first virtual object controlled by the player needs to spend long time moving around the game map to find the second virtual object. In this way, a game tempo is slow, efficiency of game interaction is low, and the game with the slow tempo has poor appeal to the player, resulting in a high player churn rate.

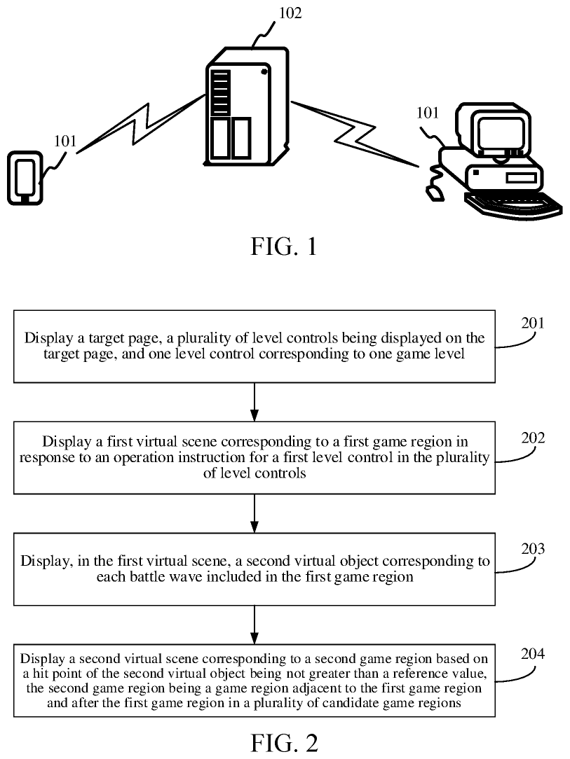

FIG. 1 is a schematic diagram of an implementation environment of a game interaction method according to an aspect described herein. As shown in FIG. 1, the implementation environment includes: a terminal device 101 and a server 102.

An application program that can provide a virtual scene is installed and run in the terminal device 101. The terminal device 101 is configured to perform the game interaction method provided in the aspects described herein.

A type of the application program that can provide the virtual scene is not limited in the aspects described herein. For example, the application program that can provide the virtual scene is a game application program, for example, a third-person shooting (TPS) game, a first-person shooting (FPS) game, a multiplayer online battle arena (MOBA) game, or a multiplayer shooting survival game. In an illustrative aspect, the game application program involved in the aspects described herein is a game application program based on frame synchronization. In other words, the game interaction method provided in the aspects described herein may be applied to the game application program based on frame synchronization.

Certainly, in addition to the game application program, the application program that can provide the virtual scene may alternatively be another type of application program, for example, a virtual reality (VR) application program, an augmented reality (AR) application program, a three-dimensional map program, a scene simulation program, a social application program, or an interaction entertainment application program.

The server 102 is configured to provide a backend service for the application program that can provide the virtual scene installed in the terminal device 101. In a possible implementation, the server 102 undertakes primary computing work, and the terminal device 101 undertakes secondary computing work. Alternatively, the server 102 undertakes secondary computing work, and the terminal device 101 undertakes primary computing work. Alternatively, a distributed computing architecture is used between the terminal device 101 and the server 102 to perform collaborative computing.

The terminal device 101 is any electronic device product that can perform human-computer interaction with a user in one or more manners such as a keyboard, a touchpad, a touch screen, a remote control, voice interaction, or a handwriting device, for example, a personal computer (PC), a mobile phone, a smart phone, a personal digital assistant (PDA), a wearable device, a pocket PC (PPC), a tablet computer, a smart head unit, a smart television, or a smart speaker. The server 102 may be a server, may be a server cluster including a plurality of server units, or may be a cloud computing service center. A communication connection is established between the terminal device 101 and the server 102 via a wired or wireless network.

A person skilled in the art can understand that the terminal device 101 and the server 102 are merely examples for description. Other existing or hereafter possible terminal devices or servers, if applicable to this application, also fall within the protection scope described herein, and are incorporated herein by reference.

The aspects described herein provide a game interaction method, and the method may be applied to the implementation environment shown in FIG. 1. For example, FIG. 2 is a flowchart of a game interaction method according to an aspect described herein. The method may be performed by the terminal device 101 in FIG. 1. As shown in FIG. 2, the method may include the following operations 201 to 204.

Operation 201: Display a target page, a plurality of level controls being displayed on the target page, and one level control corresponding to one game level.

In an illustrative aspect described herein, a game application program is installed and run in the terminal device. The game application program may be an application program that needs to be downloaded and installed, or may be an embedded program that is run in dependence on a host program. This is not limited in the aspects described herein. The embedded program is an application program that is developed based on a programming language and run in dependence on the host program. The embedded program does not need to be downloaded and installed, and only needs to be dynamically loaded in the host program to run. A user may find an embedded program that the user needs in a manner of searching, scanning, or the like. The embedded program can be used upon click/tap, and memory of the terminal is not occupied after using of the embedded program is completed and the embedded program is shut down, which is convenient. The game application program may be a first-person shooting application program, a third-person shooting application program, or another type of application program. A type of the game application program is not limited in the aspects described herein.

Related information of the game application program is displayed on a display interface of the terminal device. The related information of the game application program may be an icon of the game application program, a name of the game application program, an icon and a name of the game application program, or the like. This is not limited in the aspects described herein. The target page is displayed in response to an operation instruction for the related information of the game application program. The plurality of level controls are displayed on the target page, one level control corresponds to one game level, one game level includes at least one game region, one game region includes at least one battle wave, one battle wave corresponds to at least one virtual object, and virtual objects corresponding to battle waves included in one game region may be different. The game region is a partial region of a game map, and the game map is a map corresponding to the game application program. The operation instruction may be a click/tap operation, a selection operation in a speech manner, or another operation. This is not limited in the aspects described herein. That the game region is the partial region of the game map means that each game region is a partial region of the game map. In other words, an area of each game region is less than an area of the game map.

One game level may include one or more game regions. Different game levels may include a same quantity of game regions or different quantities of game regions. For example, a game level A includes three game regions, a game level B includes two game regions, and a game level C includes three game regions.

On the target page, if a game level corresponding to a level control is unlocked, the level control is displayed in a first target form; or if a game level corresponding to a level control is not unlocked, the level control is displayed in a second target form. That the level control is displayed in the first target form is configured for indicating that a player may enter a game region of the game level corresponding to the level control, and that the level control is displayed in the second target form is configured for indicating that the player may not enter the game region of the game level corresponding to the level control. For example, that the level control is displayed in the first target form means that the level control is displayed in white, and that the level control is displayed in the second target form means that the level control is displayed in gray. That the level control is displayed in the first target form may alternatively mean that the level control is displayed in another color, and that the level control is displayed in the second target form may alternatively mean that the level control is displayed in another color, as long as it is ensured that the first target form and the second target form are different.

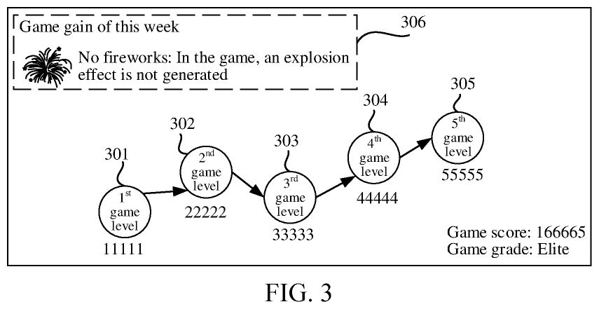

For example, FIG. 3 is a schematic diagram of displaying of a target page according to an aspect described herein. Five level controls are displayed on the target page, which are a level control 301 of a 1^{st} game level, a level control 302 of a 2^{nd} game level, a level control 303 of a 3^{rd} game level, a level control 304 of a 4th game level, and a level control 305 of a 5th game level. The game levels corresponding to the five level controls displayed in FIG. 3 are all unlocked.

In a possible implementation, target content is displayed on the target page in response to a first operation for any one of the plurality of level controls, the target content being game progress of the target object corresponding to the first virtual object in a game level corresponding to the any level control. The target content corresponds to the game level corresponding to the any level control. The target object is a player who logs in on the game application program. The first virtual object is a virtual object controlled by the target object in the game application program. The game progress of the target object in the game level corresponding to the any level control is a game region that the target object has challenged and passed through in the game level corresponding to the any level control. The first operation for the any one of the plurality of level controls may be an operation of placing a mouse on the any level control, a double-click/double-tap operation for the any level control, or another operation for the any level control. This is not limited in the aspects described herein.

Whether the game level corresponding to the any level control is unlocked is determined in response to the first operation for the any one of the plurality of level controls. The target content is displayed on the target page based on the game level corresponding to the any level control being unlocked. Reference content is displayed on the target page based on the game level corresponding to the any level control being not unlocked, where the reference content is configured for indicating that the game level corresponding to the any level control is not unlocked.

A manner of determining whether the game level corresponding to the any level control is unlocked is not limited in the aspects described herein. For example, the terminal device stores level identifiers of game levels unlocked by the target object. In response to the first operation for the any one of the plurality of level controls, a level identifier of the game level corresponding to the any level control is obtained. That the game level corresponding to the any level control is unlocked is determined based on that the level identifier of the game level corresponding to the any level control exists in the level identifiers of the game levels unlocked by the target object stored in the terminal device. That the game level corresponding to the any level control is not unlocked is determined based on that the level identifier of the game level corresponding to the any level control does not exist in the level identifiers of the game levels unlocked by the target object stored in the terminal device.

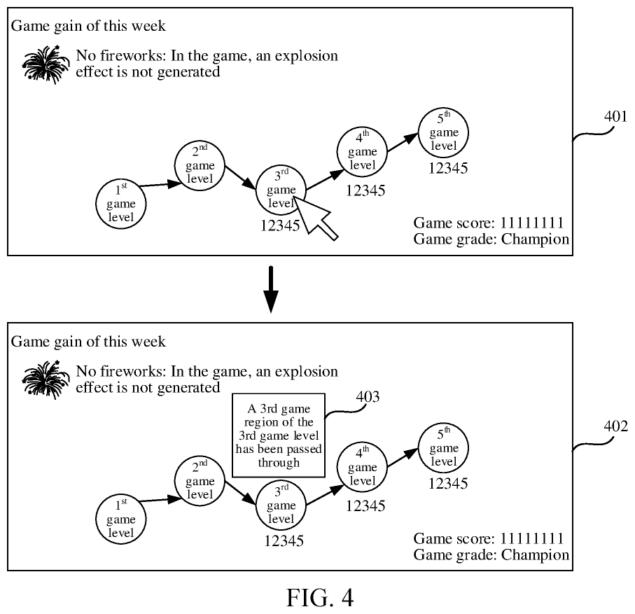

For example, FIG. 4 is a schematic diagram of displaying of a target content according to an aspect described herein. In 401, a mouse arrow is placed on a level control of the 3^{rd} game level. Since the 3^{rd} game level is unlocked, in 402, target content 403 is displayed near the level control of the 3^{rd} game level. The target content 403 corresponds to the 3^{rd} game level. The target content 403 is game progress of a target object in the 3^{rd} game level. For example, the target content 403 is “A 3^{rd} game region of the 3^{rd} game level has been passed through”.

In some aspects, prompt information is further displayed on the target page, and the prompt information is configured for indicating a game gain in a game. The game gain is an effect brought to a virtual object in the game. As shown in FIG. 3, a control 306 is prompt information, and a game gain is “No fireworks: In the game, an explosion effect is not generated”.

The game gain has a specific period, and the game gain is updated every or every other period or in some other interval. One period may be one week, may be 72 hours, or may be another duration. This is not limited in the aspects described herein. The terminal device stores a random game gain library. After one period, one game gain theme is randomly selected from the random game gain library, and a game gain corresponding to the selected game gain theme is used as a game gain of a next period.

In addition to “No Fireworks”, Table 1 below is a table of a correspondence between a game gain theme and a game gain provided in the aspects described herein.

TABLE 1

| Game gain theme | Game gain |
|---|---|
| Atmospheric | A foggy weather, having in-game visibility of 15 meters |
| pollution | The virtual object in the game is continuously poisoned, and a hit point |
| | thereof decreases by 1% per second |
| | Attack of the virtual object increases by 10% when the virtual object |
| | causes melee lifesteal damage |
| Elemental carnival | More element monsters respawn |
| | Effects of elemental skills are improved |
| | In-game currency drops from a monster decrease |
| | A monster with a skill continuously drops extra in-game currency when |
| | killed |
| No financial | In-game currency drops from a monster decrease |
| management, no | An exchange price increases by 5% every 30 seconds, and 10% of current |
| financial gains | in-game currency is obtained |
| | An option (all in) is added to the store, and when the option is selected, |
| | in-game currency changes to 80% to 120% of the original in-game |
| | currency |
| Thick skin | Armor of a monster is doubled |
| | When the armor is not broken, a hit point of the monster is not deducted |
| | under weak point attack; but if the armor is broken, damage taken at a |
| | weak point increases |
| Glass virtual | A player causes double damage while taking double damage |
| cannon | In-game currency drops from a monster increase by r % |
| | The critical rate decreases by a % each time in-game currency held by the |
| | player reaches n |
| Mechanical failure | There is a chance of consuming double bullets in each shot |
| | There is a chance of consuming double bullets in each reloading |
| | 20% of magazine bullets is automatically restored when a monster is |
| | killed under weak point attack |
| Disappearance | A monster in a non-attacking state becomes stealthy |
| | Damage taken at weak points of all monsters in a stealth state increases |
| | Non-weak point critical rates of all the monsters in the stealth state |
| | decrease |
| Cheek by jowl | If there is a teammate within 30 meters near a player, damage caused by |
| | the player to a monster increases |
| | If there is a teammate within 30 meters near the player, in-game currency |
| | drops from a monster increase |
| | If a distance between the player and a teammate exceeds 30 meters, the |
| | basic damage of the player decreases |
| Soul catcher | Basic attack of all monsters increases, and hit points are restored slowly |
| | When a monster is killed, a hit point of a player around the killed monster |
| | increases |
| | When a monster is killed, attack of the player can increase for short time, |
| | with a maximum of three layers superimposed |
| Catch a snake by | When there is a regular monster around an elite monster, a weak point |
| the head | damage rate of the elite monster increases |
| | When there is a regular monster around an elite monster, attack of the |
| | elite monster increases |
| | When there is an elite monster around a regular monster, attack of the |
| | regular monster increases |

It can be learned from Table 1 that when the game gain theme is “Atmospheric pollution”, the corresponding game gain is “A foggy weather, having in-game visibility of 15 meters. The virtual object in the game is continuously poisoned, and a hit point thereof decreases by 1% per second. Attack of the virtual object increases by 10% when the virtual object causes melee lifesteal damage”. When the game gain theme is another theme, the corresponding game gain is shown in Table 1. Details are not described herein again in the aspects described herein.

Table 1 is merely an illustrative table of the correspondence between the game gain theme and the game gain provided in the aspects described herein, and does not limit the correspondence between the game gain theme and the game gain.

In a possible implementation, level scores of the target object in game levels corresponding to the level controls are further displayed on the target page, and the level scores are determined based on performance of the target object in game regions corresponding to the game levels. For example, the performance of the target object in the game region includes but is not limited to: at least one of duration spent by the target object on passing through the game region, damage per second (DPS) of the target object in the game region, or a quantity of drops picked up by the target object in the game region.

A manner of determining the level scores of the target object in the game levels is not limited in the aspects described herein. In some aspects, for any game level, a process of determining a level score of the target object in the any game level includes: determining region scores of game regions that the target object has passed through in the any game level; and using a sum of the region scores of the passed-through game regions as the level score of the target object in the any game level.

In some aspects, for any game level, a process of determining a level score of the target object at the any game level includes: determining a highest value of region scores of game regions that the target object has passed through in the any game level; and using the highest value as the level score of the target object in the any game level.

In some aspects, for any game level, a process of determining a level score of the target object in the any game level includes: determining an average value of region scores of game regions that the target object has passed through in the any game level; and using the average value as the level score of the target object in the any game level.

For example, a process of determining the region scores of the game regions that the target object has passed through in the any game level may include: determining, for any passed-through game region, duration for the target object to pass through the game region, damage per second of the target object in the game region, and a quantity of drops picked up by the target object in the game region; and determining a region score of the target object in the game region according to the duration for the target object to pass through the game region, the damage per second of the target object in the game region, and the quantity of drops picked up by the target object in the game region.

In some aspects, a process of determining the region score of the target object in the game region according to the duration for the target object to pass through the game region, the damage per second of the target object in the game region, and the quantity of drops picked up by the target object in the game region may include: determining a sum of the duration for the target object to pass through the game region, the damage per second of the target object in the game region, and the quantity of drops picked up by the target object in the game region; and using the sum as the region score of the target object in the game region, or using a product of the sum and a level multiplier of the any game level as the region score of the target object in the game region. The level multiplier of the any game level is set empirically or adjusted according to an implementation environment. This is not limited in the aspects described herein. For example, the level multiplier of any game level may be 0.5.

Each game level corresponds to a level multiplier. Level multipliers corresponding to game levels may be the same or different. This is not limited in the aspects described herein.

As shown in FIG. 3, “11111” is a level score of the target object in the 1^{st} game level, “22222” is a level score of the target object in the 2^{nd} game level, “33333” is a level score of the target object in the 3^{rd} game level, “44444” is a level score of the target object in the 4th game level, and “55555” is a level score of the target object in the 5th game level.

In a possible implementation, at least one of a game score of the target object in the game or a game grade of the target object in the game is further displayed on the target page. The game score of the target object in the game is determined based on the level scores of the target object in the game levels corresponding to the level controls. The game grade of the target object in the game is determined based on the game score of the target object in the game.

For example, a sum of the level scores of the target object in the game levels corresponding to the level controls is used as the game score of the target object in the game. For example, an average value of the level scores of the target object in the game levels corresponding to the level controls is used as the game score of the target object in the game. For example, a highest value of the level scores of the target object in the game levels corresponding to the level controls is used as the game score of the target object in the game.

In some aspects, the terminal device stores a correspondence between the game score and the game grade. After determining the game score of the target object in the game, the terminal device determines the game grade of the target object in the game according to the game score of the target object in the game and the correspondence between the game score and the game grade.

The following Table 2 is a table of a correspondence between a game score and a game grade provided in the aspects described herein.

TABLE 2

| Game score | Game grade |
|---|---|
| 0 to 50000 | Bronze |
| 50001 to 120000 | Talent |
| 120001 to 250000 | Elite |
| 250001 to 800000 | Legend |
| 800001 to ∞ | Champion |

It can be learned from Table 2 that when the game score is 0 to 50000, a corresponding game grade is Bronze; when the game score ranges from 50001 to 120000, a corresponding game grade is Talent; when the game score ranges from 120001 to 250000, a corresponding game grade is Elite; when the game score ranges from 250001 to 800000, a corresponding game grade is Legend; and when the game score ranges from 800001 to co, a corresponding game grade is Champion.

As shown in Table 3, “Game score: 166665” is a game score of the target object in the game, and “Game grade: Elite” is a game grade of the target object in the game.

In some aspects, the terminal device stores a correspondence between a conversion value of the game score and the game grade. After determining the game score of the target object in the game, the terminal device calculates the conversion value corresponding to the game score of the target object in the game, and determines the game grade of the target object in the game according to the calculated conversion value and the correspondence between the conversion value and the game grade. A manner of calculating the conversion value corresponding to the game score of the target object in the game may be set empirically. For example, a rounded value of the game score of the target object in the game is used as the conversion value corresponding to the game score of the target object in the game. For another example, a ratio of the game score of the target object in the game to a first value is used as the conversion value corresponding to the game score of the target object in the game. The first value may be set empirically or flexibly adjusted based on a game scene. This is not limited in the aspects described herein.

The level score, the game score, the game grade, and the like that correspond to the target object may be displayed on the target page on which the level control is displayed, so that the target object can intuitively select a desired game level according to displayed information, thereby improving interaction experience of the target object, improving game appeal to the target object, and reducing a player churn rate.

During game setting, a target quantity of game levels may further be set as bonus game levels. In the bonus game level, a level score is not to be determined, and the bonus game level does not participate in calculation of the game score. For example, first two game levels are set as bonus game levels. The player only needs to complete a specified quantity of challenges within one game periodicity to obtain corresponding active bonuses. Duration of one game periodicity and the specified quantity are set by a game developer. The active bonus is also configured by the game developer.

In a possible implementation, game resources may be allocated to the target object at the end of a game season according to a game grade of the target object in the game season. A higher game grade indicates a higher resource value of the corresponding game resource. For example, a higher game score indicates a higher game grade. Therefore, the player may be incentivized to continuously refresh the game score during the game season to improve the game grade, thereby obtaining better game resources.

Operation 202: Display a first virtual scene corresponding to a first game region in response to an operation instruction for a first level control in the plurality of level controls,
a first virtual object being displayed in the first virtual scene, the first virtual scene being a virtual scene corresponding to the first game region, the first game region being a game region that a target object corresponding to the first virtual object has challenged but not passed through in a plurality of candidate game regions, and the candidate game region being a game region included in a game level corresponding to the first level control. In some aspects, an infinite resource box exists in a virtual scene corresponding to each game region, and a virtual object located in the virtual scene corresponding to the game region may obtain a resource from the infinite resource box.

In a possible implementation, whether the game level corresponding to the first level control is unlocked is determined in response to the operation instruction for the first level control in the plurality of level controls, and the first virtual scene is displayed based on the game level corresponding to the first level control being unlocked. A process of determining whether the game level corresponding to the first level control is unlocked is similar to the process of determining whether the game level corresponding to the any level control is unlocked in the foregoing operation 201, and details are not described herein again.

For example, after a game level is unlocked, the target object needs to challenge game regions included in the game level in sequence, and after the target object has challenged and passed through a previous game region, the target object challenges a next game region. Based on that the game level corresponding to the first level control is unlocked, but the target object has not challenged any game region included in the game level corresponding to the first level control, a 1^{st} game region included in the game level corresponding to the first level control is used as the first game region. Based on that the game level corresponding to the first level control is unlocked, and the target object has challenged and passed through an M^{th} game region of the game level corresponding to the first level control, an (M+1)^{th} game region of the game level corresponding to the first level control is used as the first game region. Based on that the game level corresponding to the first level control is unlocked, and the target object has challenged but not passed through an M^{th} game region of the game level corresponding to the first level control, the M^{th} game region of the game level corresponding to the first level control is used as the first game region. M is a positive integer. A status of the target object unlocking the game level and a status of the target object challenging a game region included in the unlocked game level may be extracted locally by the terminal device or obtained by the terminal device from a server.

In a possible implementation, during game developing, the game developer determines a plurality of candidate regions according to the game map, where an area of any candidate region is less than the area of the game map, and the any candidate region is a partial region of the game map; and configures a battle wave and a virtual object corresponding to each battle wave for each candidate region. When configuring the battle wave for each candidate region, the game developer configures empirically, randomly, or according to the implementation environment. This is not limited in the aspects described herein. When configuring the virtual object corresponding to each battle wave, the game developer randomly configures the virtual object from a wave content library. In some aspects, a wave theme is randomly determined from the wave content library for any battle wave, and a virtual object corresponding to the wave theme is used as a virtual object corresponding to the any battle wave. For example, the candidate region is a region covered by a circle with a radius of 40 meters. There is a collision wall at the boundary of the candidate region. The collision wall is configured to prevent the virtual object in the game from moving out of the candidate region.

The following Table 3 is a table of a correspondence between a wave theme and a virtual object provided in the aspects described herein.

TABLE 3

| Wave theme | Virtual object |
|---|---|
| Ceaseless | Role-playing game (RPG) monster*10 + |
| bombard | homing monster*10 |
| Mobile fortress | Machinegun monster*10 + shotgun monster*10 |
| Dual dragon | Dragon*2 |
| Hack and slash | Massive monster*10 |
| Dark forest | Sniper monster* 10 |
| Tremendous fire | Fire monster*10 + fire homing monster*10 + |
| | fire dagger monster*10 |
| Special challenge | Nano nest*1 |

It can be learned from Table 3 that the virtual object corresponding to the wave theme “Ceaseless bombard” is “Role-playing game (RPG) monster*10+homing monster*10”. When the wave theme is another theme, the corresponding virtual object is shown in Table 3. Details are not described herein again.

Table 3 is merely an illustrative table of the correspondence between the wave theme and the virtual object provided in the aspects described herein, and does not limit the correspondence between the wave theme and the virtual object.

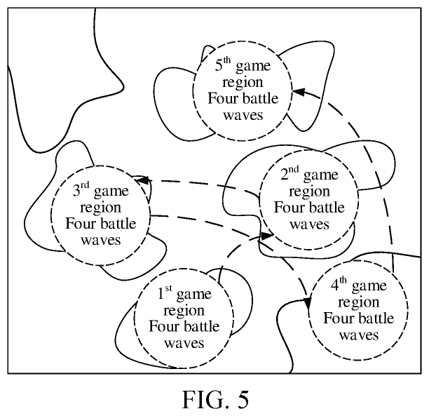

For example, FIG. 5 is a schematic diagram of game regions included in any game level and battle waves included in each game region according to an aspect described herein. The any game level includes five game regions, and each game region includes four battle waves.

The terminal device obtains the plurality of candidate regions determined according to the game map, and obtains the battle wave and the virtual object corresponding to each battle wave configured for each candidate region. The terminal device determines the plurality of candidate game regions in the plurality of candidate regions in response to the operation instruction for the first level control in the plurality of level controls; sorts the plurality of candidate game regions to obtain a sorting result, the sorting result being configured for indicating a challenge order of the target object in the plurality of candidate game regions; determines a quantity of game regions that the target object has challenged and passed through in the game level corresponding to the first level control; determines the first game region in the sorting result according to the quantity; and displays the first virtual scene corresponding to the first game region.

In some aspects, a process of determining the first game region in the sorting result according to the quantity includes: using a game region at a target position in the sorting result as the first game region, where the target position is determined according to the quantity. For example, the target position is a position corresponding to a sum of the quantity and 1.

For example, the terminal device obtains a total of five candidate regions, where each candidate region includes three battle waves. The terminal device receives the operation instruction for the first level control, determines, from the five candidate regions, a 1^{st} candidate region, a 3^{rd} candidate region, and a 5th candidate region as game regions of the game level corresponding to the first level control, and sorts the 1^{st} candidate region, the 3^{rd} candidate region, and the 5th candidate region, where an obtained sorting result is the 3^{rd} candidate region, the 5th candidate region, and the 1^{st} candidate region. It is determined that the quantity of game regions that the target object has challenged and passed through in the game level corresponding to the first level control is one. Therefore, the 5th candidate region is used as the first game region, and then a first virtual scene corresponding to the first game region is displayed.

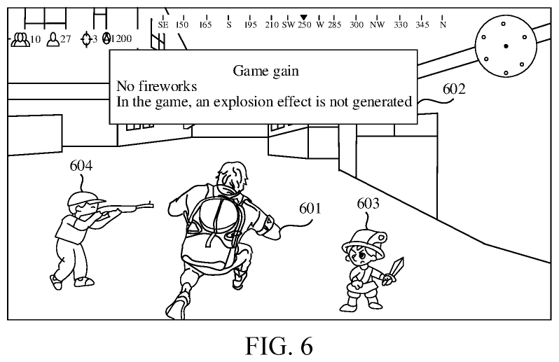

For example, FIG. 6 is a schematic diagram of displaying of a first virtual scene according to an aspect described herein. The first virtual scene is a virtual scene of a first game region of a game level corresponding to a first level control, in which a first virtual object 601 is displayed.

A manner of displaying the first virtual object in the first virtual scene is not limited in the aspects described herein. In some aspects, the first virtual object is displayed in the first virtual scene while displaying the first virtual scene. Alternatively, the first virtual scene is displayed first, and after display duration of the first virtual scene is greater than reference duration, the first virtual object is displayed in the first virtual scene in a manner of target animation. The reference duration is set empirically or adjusted according to the implementation environment. This is not limited in the aspects described herein. For example, the reference duration is one second. The target animation may be that the first virtual object lands from the aircraft, or may be in another manner. This is not limited in the aspects described herein. Displaying the first virtual object in the first virtual scene in the manner of the target animation can provide the target object with visual experience that the first virtual object is born in the first virtual scene, thereby improving the interaction experience of the target object, improving the game appeal to the target object, and reducing the player churn rate.

In a possible implementation, the prompt information is further displayed on the first virtual scene, and the prompt information is configured for indicating the game gain in the game. As shown in FIG. 6, 602 is prompt information. Displaying of the prompt information is canceled based on the display duration of the first virtual scene being greater than a third duration threshold, a target control is displayed in the first virtual scene, and the prompt information is displayed in the first virtual scene based on an operation instruction for the target control. The third duration threshold is set empirically or adjusted according to the implementation environment. This is not limited in the aspects described herein. The prompt information is displayed in the manner of the target control, so that the in-game field of view of the target object may not be affected, and the target object can see the first virtual scene clearly, thereby improving the interaction experience of the target object, improving the game appeal to the target object, and reducing the player churn rate.

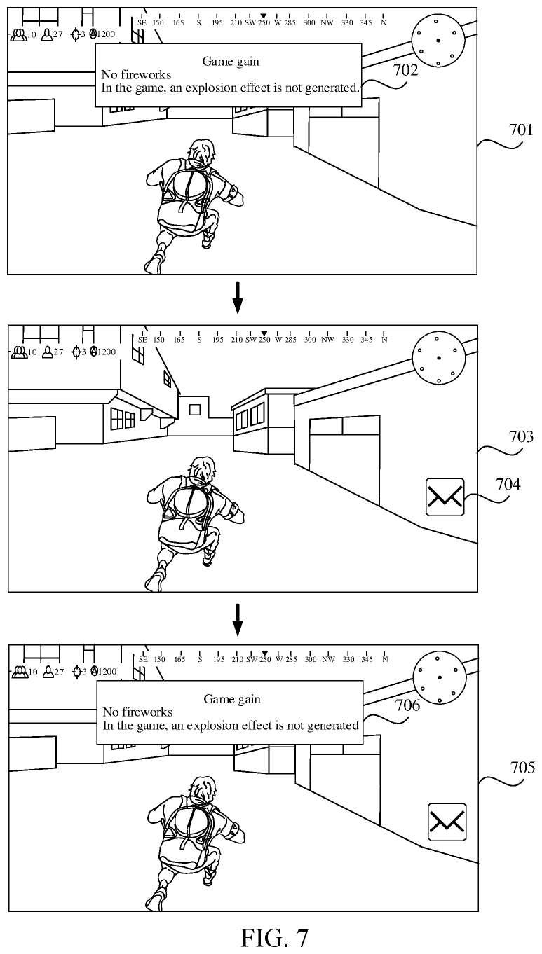

For example, FIG. 7 is a schematic diagram of a process of displaying prompt information and canceling the displaying of the prompt information in a first virtual scene according to an aspect described herein. Prompt information 702 is displayed on a page 701 configured to display the first virtual scene. When display duration of the first virtual scene is greater than a third duration threshold, a page 703 is displayed, the displaying of the prompt information on the page 703 is canceled, and a target control 704 is displayed. After an operation instruction for the target control is received, a page 705 is displayed, and prompt information 706 is displayed on the page 705.

In some aspects, a third virtual object may further be displayed in the first virtual scene, and the third virtual object is a virtual object in the same team as the first virtual object. A quantity of third virtual objects may be any value. This is not limited in the aspects described herein. For example, both 603 and 604 in FIG. 6 are third virtual objects.

Operation 203: Display, in the first virtual scene, a second virtual object corresponding to each battle wave included in the first game region.

In some aspects, a process of displaying, in the first virtual scene, the second virtual object corresponding to each battle wave included in the first game region includes: displaying, in the first virtual scene, a second virtual object corresponding to a 1^{st} battle wave included in the first game region; and displaying, starting from a 2^{nd} battle wave included in the first game region based on a second virtual object corresponding to a previous battle wave included in the first game region satisfying a display requirement, a second virtual object corresponding to a next battle wave included in the first game region in the first virtual scene, until a second virtual object corresponding to a last battle wave included in the first game region is displayed in the first virtual scene. In other words, the second virtual object corresponding to the 1^{st} battle wave included in the first game region is displayed in the first virtual scene, a second virtual object corresponding to a 2^{nd} battle wave included in the first game region is displayed in the first virtual scene based on the second virtual object corresponding to the 1^{st} battle wave satisfying the display requirement, a second virtual object corresponding to a 3^{rd} battle wave included in the first game region is displayed in the first virtual scene based on the second virtual object corresponding to the 2^{nd} battle wave satisfying the display requirement, and so on, until the second virtual object corresponding to the last battle wave included in the first game region is displayed in the first virtual scene. In this manner, second virtual objects of battle waves included in the first game region are displayed in sequence, so that the target object can control the first virtual object to perform interaction with the second virtual objects compactly, thereby improving the interaction experience, improving the game appeal to the target object, and reducing the player churn rate.

The second virtual object satisfying the display requirement means that display duration of the second virtual object is greater than a first duration threshold, or a hit point of the second virtual object is not greater than a reference value. In some aspects, the first duration threshold and the reference value are set empirically or adjusted according to the implementation environment. This is not limited in the aspects described herein. For example, the first duration threshold is five minutes, and the reference value is 0.

In other words, the second virtual object corresponding to the 1^{st} battle wave included in the first game region is displayed in the first virtual scene, the second virtual object corresponding to the 2^{nd} battle wave included in the first game region is displayed in the first virtual scene based on display duration of the second virtual object corresponding to the 1^{st} battle wave being greater than the first duration threshold, or a hit point of the second virtual object corresponding to the 1^{st} battle wave being not greater than the reference value, the second virtual object corresponding to the 3^{rd} battle wave included in the first game region is displayed in the first virtual scene based on display duration of the second virtual object corresponding to the 2^{nd} battle wave being greater than the first duration threshold, or a hit point of the second virtual object corresponding to the 2^{nd} battle wave being not greater than the reference value, and so on, until the second virtual object corresponding to the last battle wave included in the first game region is displayed in the first virtual scene.

Displaying, in the first virtual scene, the second virtual object corresponding to each battle wave included in the first game region may include but is not limited to the following two manners. In a first manner, the second virtual object corresponding to the 1^{st} battle wave included in the first game region is displayed in the first virtual scene, the second virtual object corresponding to the 2^{nd} battle wave included in the first game region is displayed in the first virtual scene based on the display duration of the second virtual object corresponding to the 1^{st} battle wave being greater than the first duration threshold, the second virtual object corresponding to the 3^{rd} battle wave included in the first game region is displayed in the first virtual scene based on the display duration of the second virtual object corresponding to the 2^{nd} battle wave being greater than the first duration threshold, and so on, until the second virtual object corresponding to the last battle wave included in the first game region is displayed in the first virtual scene.

In a second manner, the second virtual object corresponding to the 1^{st} battle wave included in the first game region is displayed in the first virtual scene, the second virtual object corresponding to the 2^{nd} battle wave included in the first game region is displayed in the first virtual scene based on the hit point of the second virtual object corresponding to the 1^{st} battle wave being not greater than the reference value, the second virtual object corresponding to the 3^{rd} battle wave included in the first game region is displayed in the first virtual scene based on the hit point of the second virtual object corresponding to the 2^{nd} battle wave being not greater than the reference value, and so on, until the second virtual object corresponding to the last battle wave included in the first game region is displayed in the first virtual scene.

Regardless of which one of the manners is used to display the second virtual object corresponding to the 1^{st} battle wave included in the first game region in the first virtual scene, the second virtual object corresponding to the 1^{st} battle wave included in the first game region may further be displayed in the first virtual scene when the display duration of the first virtual scene is greater than a second duration threshold. The second duration threshold is set empirically or adjusted according to the implementation environment. This is not limited in the aspects described herein. The second duration threshold is configured for the first virtual object to move around the first virtual scene to pick up game equipment. The game equipment may be game equipment that can be obtained without paying game currency.

For the second manner, based on the hit point of the second virtual object corresponding to the 1^{st} battle wave being not greater than the reference value, the second virtual object corresponding to the 2^{nd} battle wave included in the first game region may alternatively be displayed in the first virtual scene after target duration of staying. The target duration is set empirically or adjusted according to a game tempo. This is not limited in the aspects described herein. For example, the target duration may be 30 seconds. The target duration is configured for the first virtual object to move around the first virtual scene to pick up game equipment. The target duration is further configured for the target object to perform state adjustment, to face the second virtual object corresponding to the next battle wave.

In some aspects, a process of displaying, in the first virtual scene, the second virtual object corresponding to each battle wave included in the first game region includes: simultaneously displaying, in the first virtual scene, second virtual objects corresponding to battle waves included in the first game region.

In a possible implementation, after the second virtual object corresponding to each battle wave included in the first game region is displayed in the first virtual scene, a reference control may be further displayed in the first virtual scene. A type identifier configured for representing an object type of the second virtual object in the first virtual scene and a quantity of second virtual objects of each object type are displayed in the reference control.

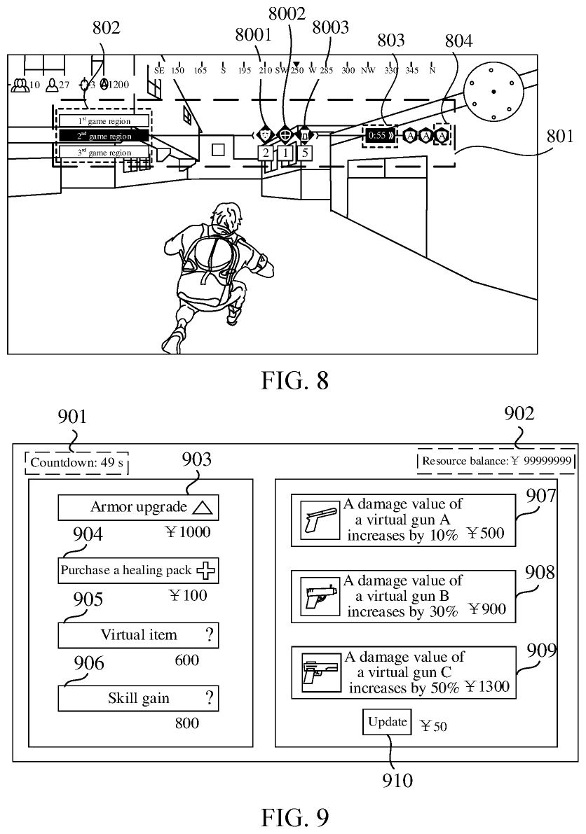

For example, FIG. 8 is a schematic diagram of displaying of another first virtual scene according to an aspect described herein. 801 is a reference control. A type identifier 8001, a type identifier 8002, and a type identifier 8003 are displayed in the reference control. A quantity of second virtual objects corresponding to the type identifier 8001 in the first virtual scene is two, a quantity of second virtual objects corresponding to the type identifier 8002 is one, and a quantity of second virtual objects corresponding to the type identifier 8003 is five.

In some aspects, a game region control 802 is further displayed in FIG. 8. The game region control 802 is configured to indicate a game region (a 1^{st} game region) that a target object has challenged and passed through, a game region (a 2^{nd} game region) that is being challenged, and a game region (a 3^{rd} game region) that still needs to be subsequently challenged in a game level corresponding to a first level control. A time control 803 is further displayed. The time control 803 is configured to indicate duration of a current battle wave. A battle wave control 804 is further displayed, and a quantity of battle wave controls 804 is configured for indicating a quantity of battle waves that still need to be faced subsequently in the game region.

Operation 204: Display a second virtual scene corresponding to a second game region based on a hit point of the second virtual object being not greater than the reference value, the second game region being a game region adjacent to the first game region and after the first game region in the plurality of candidate game regions.

For example, the hit point of the second virtual object being not greater than the reference value means that a hit point of the second virtual object corresponding to each battle wave included in the first game region is not greater than the reference value.

The plurality of candidate game regions have a specific challenge order, and the target object needs to control the first virtual object to challenge the candidate game regions in sequence according to the challenge order. The second game region is a game region adjacent to the first game region and after the first game region when the candidate game regions are arranged according to the challenge order.

In a possible implementation, a process of displaying the second virtual scene corresponding to the second game region based on the hit point of the second virtual object being not greater than the reference value includes: displaying a servicing page based on the hit point of the second virtual object being not greater than the reference value, a time value being displayed on the servicing page; and canceling, based on the time value satisfying a numerical requirement, the displaying of the servicing page, and displaying the second virtual scene. The second virtual scene is configured for the target object to control the first virtual object to perform interaction with a virtual object corresponding to each battle wave included in the second game region. The time value is a display countdown of the servicing page, and the time value changes over time. In some aspects, during the displaying of the servicing page, the servicing page may be displayed in any display manner, for example, a fade-out display manner, a hive display manner, or a chessboard display manner. Before the second virtual scene is displayed, the servicing page is displayed first, so that a sense of visual obtrusiveness caused by virtual scene switching can be reduced, thereby improving the interaction experience of the target object, improving the game appeal to the target object, and reducing the player churn rate.

Certainly, in some aspects, the second virtual scene may alternatively be directly displayed after it is determined that the hit point of the second virtual object is not greater than the reference value.

When the hit point of the virtual object corresponding to the battle wave included in the second game region is not greater than the reference value, a virtual scene corresponding to a third game region may further be displayed. A display process is similar to that of the second virtual scene. Details are not described herein again. The third game region is a game region adjacent to the second game region and after the second game region.

One game level may include one or more game regions. In the aspects described herein, an example in which the game level corresponding to the first level control includes at least two game regions, and at least a first game region and a second game region exist in the at least two game regions is used for description, but the aspects described herein are not limited thereto. In some aspects, the game level corresponding to the first level control may alternatively include one game region. In this case, if the target object has challenged but not passed through the game region, a virtual scene corresponding to the game region is displayed in response to the operation instruction for the first level control, and a second virtual object corresponding to each battle wave included in the game region is displayed in the virtual scene. Based on a hit point of the second virtual object being not greater than the reference value, the target page may be returned, or a next game level of the game level corresponding to the first level control may be automatically jumped to. If the target object has challenged and passed through the game region, reminding information may be displayed in response to the operation instruction for the first level control. The reminding information is configured for reminding the target object that a level control needs to be re-selected.

For example, FIG. 9 is a schematic diagram of displaying of a servicing page according to an aspect described herein. A control 901 displays a time value. In some aspects, a resource balance control is further displayed on the servicing page. The resource balance control is configured to indicate a resource balance of a target object in a game. As shown in FIG. 9, a control 902 is a resource balance control.

In a possible implementation, a first equipment control and a first resource value are further displayed on the servicing page, equipment corresponding to the first equipment control is configured to improve object information of the first virtual object, and the first resource value is a resource value required for obtaining the equipment corresponding to the first equipment control. As shown in FIG. 9, a control 903 is a 1^{st} first equipment control, a control 904 is a 2^{nd} first equipment control, 1000 is a resource value required for obtaining equipment corresponding to the 1^{st} first equipment control, and 100 is a resource value required for obtaining equipment corresponding to the 2^{nd} first equipment control.

The object information of the first virtual object is adjusted based on an operation instruction for the first equipment control, and the first resource value is deducted from a resource balance of the target object. In some aspects, the object information of the first virtual object includes any one of a hit point of the first virtual object and armor of the first virtual object, and a process of adjusting the object information of the first virtual object includes: increasing the hit point of the first virtual object by a target value based on the object information of the first virtual object being the hit point of the first virtual object, or increasing a grade of the armor of the first virtual object by a target grade number based on the object information of the first virtual object being the armor of the first virtual object. The armor of the first virtual object is an equipment item configured to provide a defense attribute to the first virtual object, thereby improving survivability of the first virtual object. Both the target value and the target grade number are set empirically or adjusted according to the implementation environment. This is not limited in the aspects described herein. For example, the target value is 20 and the target grade number is 1.

In some aspects, the first equipment control on the servicing page is displayed in a first form based on the object information of the first virtual object satisfying an information requirement, the first form being configured for indicating that the object information of the first virtual object has satisfied the information requirement. The first form is set empirically or flexibly adjusted based on an application scenario. This is not limited in the aspects described herein. For example, that the first equipment control is displayed in the first form may be that the first equipment control is displayed in gray.

Based on the object information of the first virtual object being a hit point of the first virtual object, the object information of the first virtual object satisfying the information requirement means that the hit point of the first virtual object is not less than a hit point threshold. Based on the object information of the first virtual object being armor of the first virtual object, the object information of the first virtual object satisfying the information requirement means that a grade of the armor of the first virtual object is not less than a grade threshold. The hit point threshold and the grade threshold are set empirically or adjusted according to the implementation environment. This is not limited in the aspects described herein. For example, the hit point threshold is 100, and the grade threshold is 10.

In a possible implementation, a second equipment control and a second resource value are further displayed on the servicing page, equipment corresponding to the second equipment control is a virtual item, and the second resource value is a resource value required for obtaining the equipment corresponding to the second equipment control. As shown in FIG. 9, a control 905 is a second equipment control, and 600 is a resource value required for obtaining equipment corresponding to the second equipment control.

The first virtual object is controlled, based on an operation instruction for the second equipment control, to obtain the virtual item corresponding to the second equipment control, and the second resource value is deducted from a resource balance of the target object.

In some aspects, the second equipment control on the servicing page is displayed in a second form based on the operation instruction for the second equipment control, the second form being configured for indicating that the first virtual object has obtained the virtual item corresponding to the second equipment control. The second form is set empirically or flexibly adjusted based on an application scenario. This is not limited in the aspects described herein. For example, that the second equipment control is displayed in the second form may be that the second equipment control is displayed in gray. The second form may be the same as the first form, or may be different from the first form.

In a possible implementation, a third equipment control and a third resource value may be further displayed on the servicing page, equipment corresponding to the third equipment control is configured to adjust a skill of the first virtual object, and the third resource value is configured for indicating a resource value required for obtaining the equipment corresponding to the third equipment control. As shown in FIG. 9, a control 906 is a third equipment control, and 800 is a resource value required for obtaining the equipment corresponding to the third equipment control.

The skill of the first virtual object is adjusted based on an operation instruction for the third equipment control and the equipment corresponding to the third equipment control, and the third resource value is deducted from a resource balance of the target object. For example, a process of adjusting the skill of the first virtual object based on the operation instruction for the third equipment control and the equipment corresponding to the third equipment control includes: obtaining the equipment corresponding to the third equipment control based on the operation instruction for the third equipment control, and adjusting the skill of the first virtual object according to the equipment corresponding to the third equipment control.

In some aspects, the terminal device stores a skill equipment library, and randomly determines, based on the operation instruction for the third equipment control, one piece of equipment from the skill equipment library as the equipment corresponding to the third equipment control. For example, the skill equipment library includes, but is not limited to, the following equipment: Individual damage taken increases by 10%, out-of-game currency drops increase by 30%, individual critical rate decreases by 5%, individual score decreases by 10%, ultimate time increases by 50%, all damage to a monster increases by 10%, damage to a shield decreases by 10%, in-game currency drops increase by 20%, a maximum hit point decreases by 10%, and weak point damage increases by 10%.

In some aspects, the terminal device may alternatively determine, based on the operation instruction for the third equipment control, alternative equipment matching the object information of the first virtual object from the skill equipment library, and randomly determine one piece of equipment from the alternative equipment as the equipment corresponding to the third equipment control. The alternative equipment matching the object information of the first virtual object is equipment that can be used by the first virtual object and that is indicated by the object information of the first virtual object. For example, if the object information of the first virtual object indicates that a hit point of the first virtual object is less than a second value, the alternative equipment matching the object information of the first virtual object is equipment that can be used by a virtual object whose hit point is less than the second value. For example, if the object information of the first virtual object indicates that an armor grade of the first virtual object is an advanced grade, the alternative equipment matching the object information of the first virtual object is equipment that can be used by a virtual object configured with advanced armor.

In a possible implementation, the third equipment control on the servicing page is displayed in a third form based on the operation instruction for the third equipment control, the third form being configured for indicating that the first virtual object has obtained the equipment corresponding to the third equipment control. The third form is set empirically or flexibly adjusted based on an application scenario. This is not limited in the aspects described herein. For example, that the third equipment control is displayed in the third form may be that the third equipment control is displayed in gray. The third form may be the same as the first form or the second form, or may be different from both the first form and the second form.

In a possible implementation, at least one fourth equipment control and a fourth resource value corresponding to each fourth equipment control may be further displayed on the servicing page, equipment corresponding to the fourth equipment control is configured to adjust a skill of a virtual item possessed by the first virtual object, and the fourth resource value corresponding to any fourth equipment control is a resource value required for obtaining the equipment corresponding to the any fourth equipment control. As shown in FIG. 9, a control 907 is a 1^{st} fourth equipment control, a control 908 is a 2^{nd} fourth equipment control, a control 909 is a 3^{rd} fourth equipment control, 500 is a resource value required for obtaining equipment corresponding to the 1^{st} fourth equipment control, 900 is a resource value required for obtaining equipment corresponding to the 2^{nd} fourth equipment control, and 1300 is a resource value required for obtaining equipment corresponding to the 3^{rd} fourth equipment control.

The skill of the virtual item possessed by the first virtual object is adjusted based on an operation instruction for the any fourth equipment control and the equipment corresponding to the any fourth equipment control, and the fourth resource value corresponding to the any fourth equipment control is deducted from a resource balance of the target object.

In some aspects, the any fourth equipment control is displayed on the servicing page in a fourth form based on the operation instruction for the any fourth equipment control, the fourth form being configured for indicating that the first virtual object has obtained the equipment corresponding to the any fourth equipment control. The fourth form is set empirically or flexibly adjusted based on an application scenario. This is not limited in the aspects described herein. For example, that the any fourth equipment control is displayed in the fourth form may be that the any fourth equipment control is displayed in gray. The fourth form may be the same as the first form, the second form, or the third form, or may be different from all the first form, the second form, and the third form.

In a possible implementation, an update control and a fifth resource value are further displayed on the servicing page, the update control is configured to update the equipment corresponding to the fourth equipment control, the fifth resource value is configured for indicating a resource value required for updating the equipment corresponding to the fourth equipment control, and the fifth resource value increases as a quantity of updates of the equipment corresponding to the fourth equipment control increases. As shown in FIG. 9, a control 910 is an update control, and 50 is a resource value required for updating the equipment corresponding to the fourth equipment control. For example, for a case in which there are a plurality of fourth equipment controls, the update control may be configured to update equipment corresponding to all of fourth equipment controls, or may be configured to update equipment corresponding to some selected fourth equipment controls. This is not limited in the aspects described herein.

The equipment corresponding to the fourth equipment control on the servicing page is updated based on an operation instruction for an update control, and the fifth resource value is deducted from a resource balance of the target object.

A plurality of equipment controls may be displayed on the servicing page, so that the target object conveniently controls the first virtual object to obtain corresponding equipment. This helps improve the interaction experience of the target object, improve the appeal of the game to the target object, and reduce the player churn rate.

In a possible implementation, a third virtual scene is displayed based on a hit point of a second virtual object corresponding to each battle wave included in a last game region of the game level corresponding to the first level control being not greater than the reference value, the third virtual scene being a virtual scene corresponding to a 1^{st} game region of a target game level, the target game level being a next game level of the game level corresponding to the first level control, and a game region included in the target game level being different from the game region included in the game level corresponding to the first level control. The third virtual scene is configured for the target object to control the first virtual object to perform interaction with a virtual object corresponding to each battle wave included in the 1^{st} game region of the target game level. A process in which the target object controls the first virtual object to perform interaction with the virtual object corresponding to each battle wave included in the 1^{st} game region of the target game level in the third virtual scene is similar to the foregoing process in which the target object controls the first virtual object to perform interaction with the virtual object corresponding to each battle wave included in the first game region of the first game level in the first virtual scene. Details are not described herein again.

In a possible implementation, in response to that the virtual object corresponding to the battle wave included in the 1^{st} game region of the target game level is the same as the virtual object corresponding to the battle wave included in the game region of the game level corresponding to the first level control, attack of the virtual object in the 1^{st} game region of the target game level is higher than attack of the virtual object in the game region of the game level corresponding to the first level control, and hit point deduction of the virtual object when the virtual object is damaged in the 1^{st} game region of the target game level is lower than hit point deduction of the virtual object when the virtual object is damaged in the game region of the game level corresponding to the first level control. In other words, a same second virtual object has different battle capabilities in different game levels and different game regions.

For example, a virtual object corresponding to a 1^{st} battle wave included in a 1^{st} game region of a 1^{st} game level is an RPG monster. Attack of the RPG monster in the 1^{st} game region of the 1^{st} game level is 5, and hit point deduction of the RPG monster is 10 when the RPG monster is damaged. A virtual object corresponding to a 1^{st} battle wave included in a 1^{st} game region of a 2^{nd} game level is also an RGP monster. Attack of the RGP monster in the 1^{st} game region of the 2^{nd} game level is 10, and hit point deduction of the RPG monster is 5 when the RPG monster is damaged.

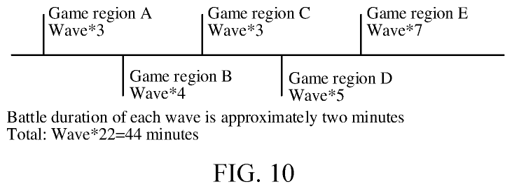

In a possible implementation, duration required for the hit point of the second virtual object corresponding to the battle wave to be not greater than the reference value is first duration. The first duration is set empirically or flexibly adjusted according to an actual scene. For example, the first duration is two minutes. Duration required for passing through a game level corresponding to each level control may also be determined according to a quantity of game regions included in each level control, a quantity of battle waves included in each game region, and duration required for a hit point of a second virtual object corresponding to a battle wave to be not greater than the reference value. For example, FIG. 10 is a schematic diagram of determining duration required for passing through a game level according to an aspect described herein. The game level includes five game regions: a game region A, a game region B, a game region C, a game region D, and a game region E. The game region A includes three battle waves, the game region B includes four battle waves, the game region C includes three battle waves, the game region D includes five battle waves, and the game region E includes seven battle waves. Therefore, it is determined that the game level includes a total of 22 battle waves. Since duration required for a hit point of a second virtual object corresponding to each battle wave to be not greater than a reference value is two minutes, it is determined that the duration required to pass through the game level is 2*22=44 minutes.

According to the foregoing method, the game map is divided into a plurality of game regions with areas smaller than that of the game map. When the operation instruction for the first level control in the plurality of level controls displayed on the target page is received, the first virtual object controlled by the target object is displayed in the first game region of the game level corresponding to the first level control. In the first game region, the first virtual object receives at least one battle wave, and enters the second game region of the game level corresponding to the first level control only when the hit point of the second virtual object included in each battle wave is not greater than the reference value. According to the method, the game map is divided into the plurality of game regions, a game is played in only one game region at a time, an area of the game region is smaller than that of the game map, and the target object can control the first virtual object to directly perform interaction with the second virtual object in the game region. Therefore, the target object does not need to frequently control the first virtual object to move in the game map to search for the second virtual object. This can reduce time for the target object to search for the second virtual object, speed up a game tempo, and improve efficiency of game interaction, thereby improving game appeal to the target object and reducing a player churn rate.

Second virtual objects of battle waves included in the first game region are displayed in sequence, so that the target object can control the first virtual object to perform interaction with the second virtual objects compactly, thereby improving interaction experience, improving the game appeal to the target object, and reducing the player churn rate.

The level score, the game score, the game grade, and the like that correspond to the target object may be displayed on the target page on which the level control is displayed, so that the target object can intuitively select a desired game level according to displayed information, thereby improving interaction experience of the target object, improving game appeal to the target object, and reducing a player churn rate.

Before the second virtual scene is displayed, the servicing page is displayed first, so that a sense of visual obtrusiveness caused by virtual scene switching can be reduced, thereby improving the interaction experience of the target object, improving the game appeal to the target object, and reducing the player churn rate. In addition, a plurality of equipment controls may be displayed on the servicing page, so that the target object conveniently controls the first virtual object to obtain corresponding equipment. This helps further improve the interaction experience of the target object, thereby further reducing the player churn rate.

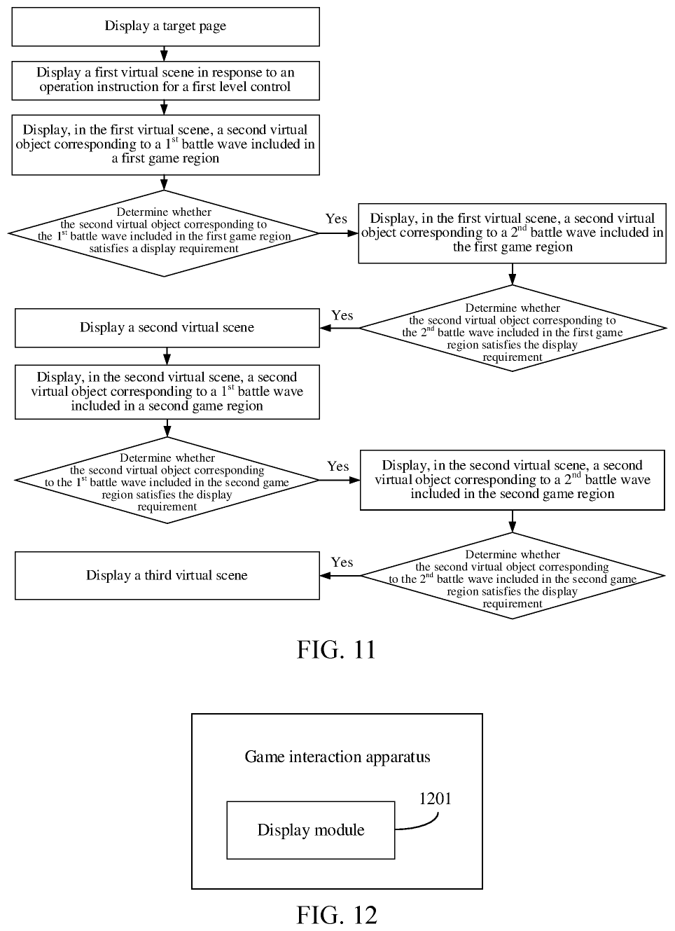

FIG. 11 is a flowchart of a game interaction method according to an aspect described herein. For example, each game level includes two game regions, and each game region includes two battle waves. The method includes the following operations 1 to 12.

Operation 1: Display a target page, a plurality of level controls being displayed on the target page, one level control corresponding to one game level, one game level including at least one game region, one game region including at least one battle wave, and the game region being a partial region of a game map. A process of displaying the target page has been described in the foregoing operation 201, and details are not described herein again.

Operation 2: Display a first virtual scene in response to an operation instruction for a first level control. The first level control is any unlocked level control in the plurality of level controls. The first virtual scene is a virtual scene corresponding to a 1^{st} game region included in a game level corresponding to the first level control. The process has been described in the foregoing operation 202, and details are not described herein again.

Operation 3: Display, in the first virtual scene, a second virtual object corresponding to a 1^{st} battle wave included in the first game region. The process has been described in the foregoing operation 203, and details are not described herein again.

Operation 4: Determine whether the second virtual object corresponding to the 1^{st} battle wave included in the first game region satisfies a display requirement. The second virtual object satisfying the display requirement means that display duration of the second virtual object is greater than a first duration threshold, or a hit point of the second virtual object is not greater than a reference value. In some aspects, the first duration threshold and the reference value are set empirically or adjusted according to the implementation environment. This is not limited in the aspects described herein. The process has been described in the foregoing operation 204, and details are not described herein again.

Operation 5: Display, based on the second virtual object corresponding to the 1^{st} battle wave included in the first game region satisfying the display requirement, a second virtual object corresponding to a 2^{nd} battle wave included in the first game region in the first virtual scene. The process has been described in the foregoing operation 204, and details are not described herein again.

Operation 6: Determine whether the second virtual object corresponding to the 2^{nd} battle wave included in the first game region satisfies the display requirement. The process has been described in the foregoing operation 204, and details are not described herein again.

Operation 7: Display a second virtual scene based on the second virtual object corresponding to the 2^{nd} battle wave included in the first game region satisfying the display requirement. The second virtual scene is a virtual scene corresponding to a 2^{nd} game region included in the game level corresponding to the first level control. The process has been described in the foregoing operation 204, and details are not described herein again.

Operation 8: Display, in the second virtual scene, a second virtual object corresponding to a 1^{st} battle wave included in a second game region. The process has been described in the foregoing operation 204, and details are not described herein again.

Operation 9: Determine whether the second virtual object corresponding to the 1^{st} battle wave included in the second game region satisfies the display requirement. The process has been described in the foregoing operation 204, and details are not described herein again.

Operation 10: Display, based on the second virtual object corresponding to the 1^{st} battle wave included in the second game region satisfying the display requirement, a second virtual object corresponding to a 2^{nd} battle wave included in the second game region in the second virtual scene. The process has been described in the foregoing operation 204, and details are not described herein again.

Operation 11. Determine whether the second virtual object corresponding to the 2^{nd} battle wave included in the second game region satisfies the display requirement. The process has been described in the foregoing operation 204, and details are not described herein again.

Operation 12: Display a third virtual scene based on the second virtual object corresponding to the 2^{nd} battle wave included in the second game region satisfying the display requirement, the third virtual scene being a virtual scene corresponding to a 1^{st} game region of a target game level, and the target game level being a next game level of the game level corresponding to the first level control. The process has been described in the foregoing operation 204, and details are not described herein again.

FIG. 12 is a schematic structural diagram of a game interaction apparatus according to an aspect described herein. As shown in FIG. 12, the apparatus includes:
a display module 1201, configured to display a target page, a plurality of level controls being displayed on the target page, one level control corresponding to one game level, one game level including at least one game region, one game region including at least one battle wave, and the game region being a partial region of a game map,
the display module 1201 being further configured to display a first virtual scene corresponding to a first game region in response to an operation instruction for a first level control in the plurality of level controls, a first virtual object being displayed in the first virtual scene, the first game region being a game region that a target object corresponding to the first virtual object has challenged but not passed through in a plurality of candidate game regions, and the candidate game region being a game region included in a game level corresponding to the first level control;
the display module 1201 being further configured to display, in the first virtual scene, a second virtual object corresponding to each battle wave included in the first game region; and the display module 1201 being further configured to display a second virtual scene corresponding to a second game region based on a hit point of the second virtual object being not greater than a reference value, the second game region being a game region adjacent to the first game region and after the first game region in the plurality of candidate game regions, and the second virtual scene being configured for the target object to control the first virtual object to perform interaction with a virtual object corresponding to each battle wave included in the second game region.

In a possible implementation, the display module 1201 is configured to: display, in the first virtual scene, a second virtual object corresponding to a 1^{st} battle wave included in the first game region; and display, starting from a 2^{nd} battle wave included in the first game region based on a second virtual object corresponding to a previous battle wave included in the first game region satisfying a display requirement, a second virtual object corresponding to a next battle wave included in the first game region in the first virtual scene, until a second virtual object corresponding to a last battle wave included in the first game region is displayed in the first virtual scene, the second virtual object satisfying the display requirement meaning that display duration of the second virtual object is greater than a first duration threshold, or the hit point of the second virtual object is not greater than the reference value.

In a possible implementation, the display module 1201 is configured to: display a servicing page based on the hit point of the second virtual object being not greater than the reference value, a time value being displayed on the servicing page, the time value being a display countdown of the servicing page, and the time value changing over time; and cancel, based on the time value satisfying a numerical requirement, the displaying of the servicing page, and display the second virtual scene.

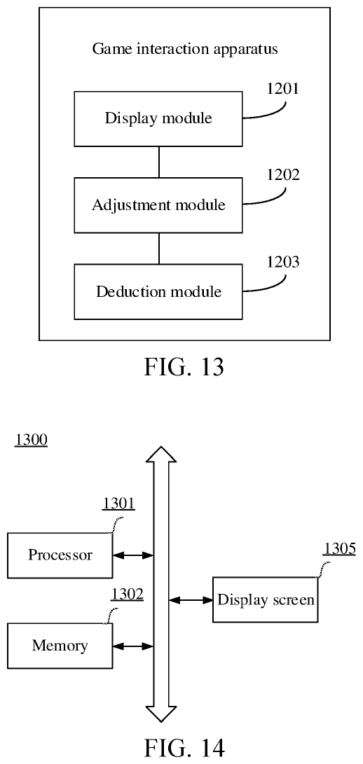

In a possible implementation, a first equipment control and a first resource value are further displayed on the servicing page, equipment corresponding to the first equipment control is configured to improve object information of the first virtual object, and the first resource value is a resource value required for obtaining the equipment corresponding to the first equipment control; and referring to FIG. 13, the apparatus further includes:
an adjustment module 1202, configured to adjust the object information of the first virtual object based on an operation instruction for the first equipment control; and
a deduction module 1203, configured to deduct the first resource value from a resource balance of the target object.

In a possible implementation, the object information of the first virtual object includes any one of a hit point of the first virtual object and armor of the first virtual object; and
the adjustment module 1202 is configured to: increase the hit point of the first virtual object by a target value based on the object information of the first virtual object being the hit point of the first virtual object; or increase a grade of the armor of the first virtual object by a target grade number based on the object information of the first virtual object being the armor of the first virtual object.

In a possible implementation, the display module 1201 is further configured to display, based on the object information of the first virtual object satisfying an information requirement, the first equipment control on the servicing page in a first form, the first form being configured for indicating that the object information of the first virtual object has satisfied the information requirement,
the object information of the first virtual object being a hit point of the first virtual object, and the object information of the first virtual object satisfying the information requirement meaning that the hit point of the first virtual object is not less than a hit point threshold, or the object information of the first virtual object being armor of the first virtual object, and the object information of the first virtual object satisfying the information requirement meaning that a grade of the armor of the first virtual object is not less than a grade threshold.

In a possible implementation, a second equipment control and a second resource value are further displayed on the servicing page, equipment corresponding to the second equipment control is a virtual item, and the second resource value is a resource value required for obtaining the equipment corresponding to the second equipment control; and
the apparatus further includes:
a control module, configured to control, based on an operation instruction for the second equipment control, the first virtual object to obtain the virtual item corresponding to the second equipment control; and
the deduction module 1203 is further configured to deduct the second resource value from a resource balance of the target object.

In a possible implementation, the display module 1201 is further configured to display, based on the operation instruction for the second equipment control, the second equipment control on the servicing page in a second form, the second form being configured for indicating that the first virtual object has obtained the virtual item corresponding to the second equipment control.

In a possible implementation, a third equipment control and a third resource value are further displayed on the servicing page, equipment corresponding to the third equipment control is configured to adjust a skill of the first virtual object, and the third resource value is configured for indicating a resource value required for obtaining the equipment corresponding to the third equipment control;
the adjustment module 1202 is further configured to adjust the skill of the first
virtual object based on an operation instruction for the third equipment control and the equipment corresponding to the third equipment control; and
the deduction module 1203 is further configured to deduct the third resource value from a resource balance of the target object.

In a possible implementation, the display module 1201 is further configured to display, based on the operation instruction for the third equipment control, the third equipment control on the servicing page in a third form, the third form being configured for indicating that the first virtual object has obtained the equipment corresponding to the third equipment control.

In a possible implementation, at least one fourth equipment control and a fourth resource value corresponding to each fourth equipment control are further displayed on the servicing page, equipment corresponding to the fourth equipment control is configured to adjust a skill of a virtual item possessed by the first virtual object, and the fourth resource value corresponding to the any fourth equipment control is a resource value required for obtaining the equipment corresponding to the any fourth equipment control;
the adjustment module is further configured to adjust the skill of the virtual item possessed by the first virtual object based on an operation instruction for the any fourth equipment control and the equipment corresponding to the any fourth equipment control; and
the deduction module 1203 is further configured to deduct the fourth resource value corresponding to the any fourth equipment control from a resource balance of the target object.

In a possible implementation, the display module 1201 is further configured to display, based on the operation instruction for the any fourth equipment control, the any fourth equipment control on the servicing page in a fourth form, the fourth form being configured for indicating that the first virtual object has obtained the equipment corresponding to the any fourth equipment control.

In a possible implementation, an update control and a fifth resource value are further displayed on the servicing page, the update control is configured to update the equipment corresponding to the fourth equipment control, the fifth resource value is configured for indicating a resource value required for updating the equipment corresponding to the fourth equipment control, and the fifth resource value increases as a quantity of updates of the equipment corresponding to the fourth equipment control increases; and
the apparatus further includes:
an update module, configured to update, based on an operation instruction for the update control, the equipment corresponding to the fourth equipment control on the servicing page; and
the deduction module 1203 is further configured to deduct the fifth resource value from a resource balance of the target object.

In a possible implementation, level scores of the target object in game levels corresponding to the level controls are further displayed on the target page, and the level scores are determined based on performance of the target object in game regions corresponding to the game levels.

In a possible implementation, at least one of a game score of the target object in a game or a game grade of the target object in the game is further displayed on the target page.

The game score of the target object in the game is determined based on the level scores of the target object in the game levels corresponding to the level controls, and the game grade of the target object in the game is determined based on the game score of the target object in the game.

In a possible implementation, the apparatus further includes:
an obtaining module, configured to obtain a plurality of candidate regions determined according to the game map, an area of any candidate region being less than an area of the game map;
a determining module, configured to determine the plurality of candidate game regions in the plurality of candidate regions in response to the operation instruction for the first level control in the plurality of level controls;
a sorting module, configured to sort the plurality of candidate game regions to obtain a sorting result, the sorting result being configured for indicating a challenge order of the target object in the plurality of candidate game regions;
the determining module is further configured to: determine a quantity of game regions that the target object has challenged and passed through in the game level corresponding to the first level control; and determine the first game region in the sorting result according to the quantity; and
a display module 1201, configured to display the first virtual scene corresponding to the first game region.

In a possible implementation, the display module 1201 is further configured to display a third virtual scene based on a hit point of a second virtual object corresponding to each battle wave included in a last game region of the game level corresponding to the first level control being not greater than the reference value, the third virtual scene being a virtual scene corresponding to a 1^{st} game region of a target game level, the target game level being a next game level of the game level corresponding to the first level control, and a game region included in the target game level being different from the game region included in the game level corresponding to the first level control.

In a possible implementation, the display module 1201 is further configured to display target content on the target page in response to a first operation for any one of the plurality of level controls, the target content being game progress of the target object corresponding to the first virtual object in a game level corresponding to the any level control.

In a possible implementation, the display module 1201 is configured to: determine, in response to the first operation for the any one of the plurality of level controls, whether the game level corresponding to the any level control is unlocked; and display the target content on the target page based on the game level corresponding to the any level control being unlocked.

Through the foregoing apparatus, the game map is divided into a plurality of game regions with areas smaller than that of the game map. When the operation instruction for the first level control in the plurality of level controls displayed on the target page is received, the first virtual object controlled by the target object is displayed in the first game region of the game level corresponding to the first level control. In the first game region, the first virtual object receives at least one battle wave, and enters the second game region of the game level corresponding to the first level control only when the hit point of the second virtual object included in each battle wave is not greater than the reference value. The game map is divided into the plurality of game regions, a game is played in only one game region at a time, an area of the game region is smaller than that of the game map, and the target object can control the first virtual object to directly perform interaction with the second virtual object in the game region. Therefore, the target object does not need to frequently control the first virtual object to move in the game map to search for the second virtual object. This can reduce time for the target object to search for the second virtual object, speed up a game tempo, and improve efficiency of game interaction, thereby improving game appeal to the target object and reducing a player churn rate.

Second virtual objects of battle waves included in the first game region are displayed in sequence, so that the target object can control the first virtual object to perform interaction with the second virtual objects compactly, thereby improving interaction experience, improving the game appeal to the target object, and reducing the player churn rate.

The level score, the game score, the game grade, and the like that correspond to the target object may be displayed on the target page on which the level control is displayed, so that the target object can intuitively select a desired game level according to displayed information, thereby improving the interaction experience of the target object, improving the game appeal to the target object, and reducing the player churn rate.

Before the second virtual scene is displayed, the servicing page is displayed first, so that a sense of visual obtrusiveness caused by virtual scene switching can be reduced, thereby improving the interaction experience of the target object, improving the game appeal to the target object, and reducing the player churn rate. In addition, a plurality of equipment controls may be displayed on the servicing page, so that the target object conveniently controls the first virtual object to obtain corresponding equipment. This helps further improve the interaction experience of the target object, thereby further reducing the player churn rate.

When the apparatus provided above implements the functions of the apparatus, only division of the foregoing function modules is used as an example for description. During actual application, the foregoing functions may be allocated to and completed by different function modules according to requirements. That is, an internal structure of the device is divided into different function modules, to complete all or some of the functions described above. In addition, the apparatus and method aspects provided in the foregoing aspects belong to the same conception. For a specific implementation process, reference may be made to the method aspects, and details are not described herein again.

FIG. 14 is a structural block diagram of a terminal device 1300 according to an illustrative aspect described herein. The terminal device 1300 may be a portable mobile terminal, for example, a smartphone, a tablet computer, a player, a notebook computer, or a desktop computer. The terminal device 1300 may also be referred to as another name such as user equipment, a portable terminal, a laptop terminal, or a desktop terminal.

Generally, the terminal device 1300 includes: a processor 1301 and a memory 1302.

The processor 1301 may include one or more processing cores, for example, a 4-core processor or an 8-core processor. The processor 1301 may be implemented by using at least one hardware form of a digital signal processor (DSP), a field-programmable gate array (FPGA), and a programmable logic array (PLA). The processor 1301 may further include a main processor and a coprocessor. The main processor is a processor configured to process data in an active state, also referred to as a central processing unit (CPU). The coprocessor is a low-power consumption processor configured to process data in a standby state. In some aspects, the processor 1301 may be integrated with a graphics processing unit (GPU). The GPU is configured to render and draw content that needs to be displayed on a display screen. In some aspects, the processor 1301 may further include an artificial intelligence (AI) processor. The AI processor is configured to process computing operations related to machine learning.

The memory 1302 may include one or more computer-readable storage media. The computer-readable storage medium may be non-transient. The memory 1302 may further include a high-speed random access memory and a nonvolatile memory, for example, one or more disk storage devices or flash storage devices. In some aspects, the non-transitory computer-readable storage medium in the memory 1302 is configured to store at least one instruction, and the at least one instruction is configured to be executed by the processor 1301 to implement the game interaction method provided in the method aspects described herein.

In some aspects, the terminal device 1300 may further include: a display screen 1305.

The display screen 1305 is configured to display a user interface (UI). The UI may include a graph, text, an icon, a video, and any combination thereof. When the display screen 1305 is a touch display screen, the display screen 1305 is further capable of collecting touch signals on or above a surface of the display screen 1305. The touch signal may be inputted to the processor 1301 as a control signal for processing. In this case, the display screen 1305 may also be configured to provide virtual buttons and/or virtual keyboards, also referred to as soft buttons and/or soft keyboards. In some aspects, there may be one display screen 1305 arranged on a front panel of the terminal device 1300. In some other aspects, there may be at least two display screens 1305 respectively arranged on different surfaces of the terminal device 1300 or in a folded design. In some other aspects, the display screen 1305 may be a flexible display screen arranged on a curved or folded surface of the terminal device 1300. Even further, the display screen 1305 may be arranged in a non-rectangular irregular pattern, that is, a special-shaped screen. The display screen 1305 may be prepared by using a material such as a liquid crystal display (LCD), an organic light-emitting diode (OLED), or the like. For example, a target page, a first virtual scene, a second virtual object, a second virtual scene, and the like are displayed through the display screen 1305.

A person skilled in the art may understand that the structure shown in FIG. 14 constitutes no limitation to the terminal device 1300, and the terminal device may include more or fewer components than those shown in the figure, or some components may be combined, or a different component arrangement may be used.

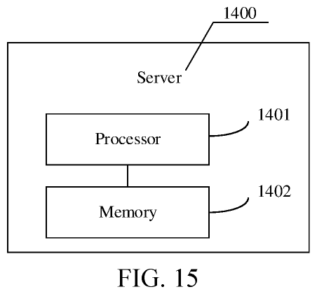

FIG. 15 is a schematic structural diagram of a server according to an aspect described herein. The server 1400 may vary greatly because a configuration or performance varies, and may include one or more central processing units (CPU) 1401 and one or more memories 1402. The one or more memories 1402 store at least one piece of program code, and the at least one piece of program code is loaded and executed by the one or more processors 1401 to implement the game interaction methods provided in the foregoing various method aspects. Certainly, the server 1400 may also have a wired or wireless network interface, a keyboard, an input/output interface and other components, to facilitate input/output. The server 1400 may also include other components for implementing device functions. Details are not described herein.

In an illustrative aspect, a nonvolatile computer-readable storage medium is further provided, having at least one piece of program code stored therein, the at least one piece of program code being loaded and executed by a processor to cause a computer to implement any one of the foregoing game interaction methods.

In some aspects, the nonvolatile computer-readable storage medium may be a read-only memory (ROM), a random access memory (RAM), a compact disc read-only memory (CD-ROM), a magnetic tape, a floppy disk, an optical data storage device, and the like.

In an illustrative aspect, a computer program or a computer program product is further provided, having at least one computer instruction stored therein, the at least one computer instruction being loaded and executed by a processor to cause a computer to implement any one of the foregoing game interaction methods.

The information (including, but not limited to, user equipment information, user personal information, and the like), data (including, but not limited to, data for analysis, stored data, displayed data, and the like), and signals involved in this application all are authorized by the user or fully authorized by each party, and the collection, use, and processing of relevant data need to comply with relevant laws and regulations of relevant countries and regions. For example, the target page and the virtual scene involved in this application are obtained under full authorization.

“A plurality of” mentioned in this specification means two or more. “And/or” describes an association relationship between associated objects and represents that three relationships may exist. For example, A and/or B may represent the following three cases: Only A exists, both A and B exist, and only B exists. The character “/” generally represents an “or” relationship between the associated objects.

The foregoing descriptions are merely illustrative aspects described herein, but are not intended to limit this application. Any modification, equivalent replacement, or improvement made within the principle described herein shall fall within the protection scope described herein.

What is claimed is:

1. A game interaction method, performed by a terminal device, the method comprising:
establishing a virtual game environment wherein a plurality of level controls are configured for display on a target page, wherein each level control corresponds to a different one game level, wherein each game level comprises at least one game region, wherein each game region comprises at least one battle wave, and wherein each game region consists of a partial region of a game map;
receiving first user input for a first level control of the plurality of level controls;
responsive to the first user input, displaying a first virtual scene corresponding to a first game region, wherein said first virtual scene comprises a first virtual object, wherein the first game region is a game region that a target object corresponding to the first virtual object has challenged but not passed through in a plurality of candidate game regions, and wherein the candidate game region is a game region of a game level corresponding to the first level control;
displaying, in the first virtual scene, a second virtual object corresponding to each battle wave of the first game region; and
initiating a second virtual scene corresponding to a second game region based on determining a hit point of the second virtual object being not greater than a reference value, wherein the second game region is a game region adjacent to the first game region and after the first game region in the plurality of candidate game regions, and the second virtual scene is configured for the target object to control the first virtual object to perform interaction with a virtual object corresponding to each battle wave comprised in the second game region.

2. The method according to claim 1, wherein one or more battle regions comprises a plurality of battle waves, and the method further comprising:
for each battle region comprising a plurality of battle waves, starting with the 2^{nd} battle wave in each of said battle regions, displaying the second virtual object corresponding to said battle wave based on a second virtual object corresponding to a previous battle wave satisfying a display requirement, until a second virtual object corresponding to a last battle wave is displayed in the first virtual scene;
wherein the display requirement comprises a display duration of the second virtual object being greater than a first duration threshold, or a hit point value of the second virtual object is not greater than a predetermined value.

3. The method according to claim 1, wherein the displaying a second virtual scene corresponding to a second game region based on a hit point of the second virtual object being not greater than a reference value comprises:
displaying a servicing page based on the hit point of the second virtual object being not greater than the reference value, a time value being displayed on the servicing page, the time value being a display countdown of the servicing page, and the time value changing over time; and
canceling, based on the time value satisfying a numerical requirement, the displaying of the servicing page, and displaying the second virtual scene.

4. The method according to claim 3, wherein a first equipment control and a first resource value are further displayed on the servicing page, equipment corresponding to the first equipment control is configured to improve object information of the first virtual object, and the first resource value is a resource value required for obtaining the equipment corresponding to the first equipment control; and
the method further comprises:
adjusting the object information of the first virtual object based on an operation instruction for the first equipment control; and
deducting the first resource value from a resource balance of the target object.

5. The method according to claim 4, wherein the object information of the first virtual object comprises any one of a hit point of the first virtual object or armor of the first virtual object; and
the adjusting the object information of the first virtual object comprises:
increasing the hit point of the first virtual object by a target value based on the object information of the first virtual object being the hit point of the first virtual object; or
increasing a grade of the armor of the first virtual object by a target grade number based on the object information of the first virtual object being the armor of the first virtual object.

6. The method according to claim 4, further comprising:
displaying, based on the object information of the first virtual object satisfying an information requirement, the first equipment control on the servicing page in a first form, the first form being configured for indicating that the object information of the first virtual object has satisfied the information requirement,
the object information of the first virtual object being a hit point of the first virtual object, and the object information of the first virtual object satisfying the information requirement being that the hit point of the first virtual object is not less than a hit point threshold, or the object information of the first virtual object being armor of the first virtual object, and the object information of the first virtual object satisfying the information requirement being that a grade of the armor of the first virtual object is not less than a grade threshold.

7. The method according to claim 3, wherein a second equipment control and a second resource value are further displayed on the servicing page, wherein equipment corresponding to the second equipment control is a virtual item, and the second resource value is a resource value required for obtaining the equipment corresponding to the second equipment control; and
the method further comprises:
controlling, based on an operation instruction for the second equipment control, the first virtual object to obtain the virtual item corresponding to the second equipment control; and
deducting the second resource value from a resource balance of the target object.

8. The method according to claim 7, further comprising:
displaying, based on the operation instruction for the second equipment control, the second equipment control on the servicing page in a second form, the second form being configured for indicating that the first virtual object has obtained the virtual item corresponding to the second equipment control.

9. The method according to claim 3, wherein a third equipment control and a third resource value are further displayed on the servicing page, equipment corresponding to the third equipment control is configured to adjust a skill of the first virtual object, and the third resource value is configured for indicating a resource value required for obtaining the equipment corresponding to the third equipment control; and
the method further comprises:
adjusting the skill of the first virtual object based on an operation instruction for the third equipment control and the equipment corresponding to the third equipment control; and
deducting the third resource value from a resource balance of the target object.

10. The method according to claim 9, further comprising:
displaying, based on the operation instruction for the third equipment control, the third equipment control on the servicing page in a third form, the third form being configured for indicating that the first virtual object has obtained the equipment corresponding to the third equipment control.

11. The method according to claim 3, wherein at least one fourth equipment control and a fourth resource value corresponding to each fourth equipment control are further displayed on the servicing page, equipment corresponding to the fourth equipment control is configured to adjust a skill of a virtual item possessed by the first virtual object, and the fourth resource value corresponding to any fourth equipment control is a resource value required for obtaining the equipment corresponding to the any fourth equipment control; and
the method further comprises:
adjusting the skill of the virtual item possessed by the first virtual object based on an operation instruction for the any fourth equipment control and the equipment corresponding to the any fourth equipment control; and
deducting the fourth resource value corresponding to the any fourth equipment control from a resource balance of the target object.

12. The method according to claim 11, further comprising:
displaying, based on the operation instruction for the any fourth equipment control, the fourth equipment control on the servicing page in a fourth form, the fourth form being configured for indicating that the first virtual object has obtained the equipment corresponding to the any fourth equipment control.

13. The method according to claim 11, wherein an update control and a fifth resource value are further displayed on the servicing page, the update control is configured to update the equipment corresponding to the fourth equipment control, the fifth resource value is configured for indicating a resource value required for updating the equipment corresponding to the fourth equipment control, and the fifth resource value increases as a quantity of updates of the equipment corresponding to the fourth equipment control increases; and
the method further comprises:
updating, based on an operation instruction for the update control, the equipment corresponding to the fourth equipment control on the servicing page; and
deducting the fifth resource value from a resource balance of the target object.

14. The method of claim 1, wherein at least one of a game score of the target object in a game or a game grade of the target object in the game is displayed on the target page; and the method further comprises:
determining the game score of the target object in the game based on level scores of the target object in the game levels corresponding to the level controls; and
determining the game grade of the target object in the game based on the game score of the target object in the game.

15. The method of claim 1, further comprising:
obtaining a plurality of candidate regions determined according to the game map, an area of any candidate region being less than an area of the game map;
determining a plurality of candidate game regions in response to an operation instruction for the first level control in the plurality of level controls;
sorting the plurality of candidate game regions to obtain a sorting result, the sorting result being configured for indicating a challenge order of the target object in the plurality of candidate game regions;
determining a quantity of game regions that the target object has challenged and passed through in the game level corresponding to the first level control;
determining the first game region in the sorting result according to the quantity; and
displaying the first virtual scene corresponding to the first game region.

16. One or more non-transitory computer readable media comprising computer readable instructions which, when executed, configure a data processing system to perform:
establishing a virtual game environment wherein a plurality of level controls are configured for display on a target page, wherein each level control corresponds to a different one game level, wherein each game level comprises at least one game region, wherein each game region comprises at least one battle wave, and wherein each game region consists of a partial region of a game map;
receiving first user input for a first level control of the plurality of level controls;
responsive to the first user input, displaying a first virtual scene corresponding to a first game region, wherein said first virtual scene comprises a first virtual object, wherein the first game region is a game region that a target object corresponding to the first virtual object has challenged but not passed through in a plurality of candidate game regions, and wherein the candidate game region is a game region of a game level corresponding to the first level control;
displaying, in the first virtual scene, a second virtual object corresponding to each battle wave of the first game region; and
initiating a second virtual scene corresponding to a second game region based on determining a hit point of the second virtual object being not greater than a reference value, wherein the second game region is a game region adjacent to the first game region and after the first game region in the plurality of candidate game regions, and the second virtual scene is configured for the target object to control the first virtual object to perform interaction with a virtual object corresponding to each battle wave comprised in the second game region.

17. The computer readable media of claim 16, wherein one or more battle regions comprises a plurality of battle waves, and the instructions, when executed, further configure the data processing system to perform:
for each battle region comprising a plurality of battle waves, starting with the 2^{nd} battle wave in each of said battle regions, displaying the second virtual object corresponding to said battle wave based on a second virtual object corresponding to a previous battle wave satisfying a predetermined condition, until a second virtual object corresponding to a last battle wave is displayed in the first virtual scene.

18. The computer readable media of claim 17, wherein the predetermined condition comprises a display duration of the second virtual object being greater than a first duration threshold, or a hit point value of the second virtual object is not greater than a predetermined value.

19. A system, comprising:
a processor; and
memory storing computer readable instructions which, when executed, configure the system to perform:
establishing a virtual game environment wherein a plurality of level controls are configured for display on a target page, wherein each level control corresponds to a different one game level, wherein each game level comprises at least one game region, wherein each game region comprises at least one battle wave, and wherein each game region consists of a partial region of a game map;
receiving first user input for a first level control of the plurality of level controls;
responsive to the first user input, displaying a first virtual scene corresponding to a first game region, wherein said first virtual scene comprises a first virtual object, wherein the first game region is a game region that a target object corresponding to the first virtual object has challenged but not passed through in a plurality of candidate game regions, and wherein the candidate game region is a game region of a game level corresponding to the first level control;
displaying, in the first virtual scene, a second virtual object corresponding to each battle wave of the first game region; and
initiating a second virtual scene corresponding to a second game region based on determining a hit point of the second virtual object being not greater than a reference value, wherein the second game region is a game region adjacent to the first game region and after the first game region in the plurality of candidate game regions, and the second virtual scene is configured for the target object to control the first virtual object to perform interaction with a virtual object corresponding to each battle wave comprised in the second game region.

20. The system of claim 19, wherein one or more battle regions comprises a plurality of battle waves, and the instructions, when executed, further configure the system to perform:
for each battle region comprising a plurality of battle waves, starting with the 2^{nd} battle wave in each of said battle regions, displaying the second virtual object corresponding to said battle wave based on a second virtual object corresponding to a previous battle wave satisfying a predetermined condition, until a second virtual object corresponding to a last battle wave is displayed in the first virtual scene,
wherein the predetermined condition comprises a display duration of the second virtual object being greater than a first duration threshold, or a hit point value of the second virtual object is not greater than a predetermined value.
